(19) United States
(12) Patent Application Publication
(10) Pub. No.: US 2016/0353714 A1
(43) Pub. Date: Dec. 8, 2016

(54) HORIZONTAL TOP-BAR BEEHIVE

(71) Applicant: Manzer Apiary Inc., Seabrook (CA)

(72) Inventors: Brian Roy Manzer, Seabrook (CA); Owen Mitchell Manzer, Ashmore (CA)

(21) Appl. No.: 15/133,796

(22) Filed: Apr. 20, 2016

Related U.S. Application Data
(60) Provisional application No. 62/171,285, filed on Jun. 5, 2015.

(30) Foreign Application Priority Data
Nov. 3, 2015 (CA) 2911008

(51) Int. Cl. A01K 47/06

(52) U.S. Cl. CPC A01K 47/06

(57) ABSTRACT

The present invention relates to a horizontal top-bar beehive consisting of a hive box, supporting structures, a hinged insulated top, a hinged top support structure, and a top and bottom ventilation system that provides ambient temperature and moisture control. The beehive contains top-bars reinforced to reduce comb breakage during comb removal. The insulated hinged top is metal cladded to protect the hive from elements and its insulation prevents condensation in winter. The insulated top and advanced ventilation system reduces or eliminates beehive winter mortality and the need for extensive wrapping or insulating of the hive in preparation for winter. The top support structure facilitates top removal and prevents hive contamination and infestation by preventing the top from resting on the ground. The hinged top structure and associated support allow for easy comb removal with minimal disturbance of the bees thus reducing the need for protective equipment and fumigation, thus making the hive an optimum choice for non-commercial bee keepers. The hive is equipped with an inspection window that allows observations without disturbing the hive.

### BACKGROUND

Domestic beekeeping has been practiced worldwide for centuries. The practice has been widely used for the production of honey and wax, and most recently strictly for commercial pollination of desirable agricultural products. Bees play a very significant part in the pollination of desirable crops of human relevance, there are estimates that as much as 30% of crops that the human species relies upon depend on bees for their pollination. During the last decades the Western world has seen significant increases in beehive mortality largely due to parasitic introductions and diseases. Good maintenance practices are of paramount importance.

Domestic beehives have been constructed from a wide variety of materials and shapes. The more common commercial beehives available in the market place are known in the art as the Langstroth hive, the Warre hive, and the top-bar hives. The Langstroth hives consist of a series of stacked rectangular boxes made from a variety of materials that can be stacked to expand the usable space for the bees. Inside the boxes, eight or ten fully framed comb frames are hung parallel to each other. The lowest or tallest box, the brood box, houses the bee colony. Boxes containing the comb frames are added to the top as honey production increases. Winter management in northern temperate climates involves wrapping and insulating the boxes and/or moving the hive to protected areas.

The Warre hive is similar to the Langstroth hive in that the boxes are stacked vertically, but it differs in two principal aspects, as the hive expands the new boxes are added to the bottom instead of the top, and rather than full framed comb frames the Warre uses top-bars only for comb support.

The top-bar hives also known as Kenya hives were initially developed as low cost simple alternatives to the destructive harvesting of wild honey in warm regions such as Kenya. The top-bar hive uses a similar approach to the comb support as the Warre hive, rather than a frame the bees build and suspend the comb from a top-bar sitting horizontally across the top of the box cavity. Unlike the Langstroth and Warre the Kenyan hive expands itself horizontally as the comb top-bar are stacked horizontally perpendicular to the length of the box. During the last decade the horizontal top-bar hive (HTBH) has gained popularity among non-commercial beekeepers in North America because of their simplicity, ease of use and particularly ease of harvesting.

It is known in the art that, particularly in northern latitudes, winter condensation inside the hive rather than temperature is a major factor in winter survival of the hive. The issue is partially resolved by a winterizing regimen involving wrapping the hive in insulation or trying to move the hive to protected location. Reducing in situ winter moisture in the hive remains a challenge. Another well-known issue is the potential for honeycomb breakage during removal or observation. The simplicity of the top-bar in HTBH hives is considered an advantage by some, however, the lack of comb frames makes the honeycomb susceptible to breakage particularly during warm periods. The ability to easily remove the top of the HTBH hive lends for easy maintenance. The HTBH top tends to be large and heavy, as in most hives during maintenance the top is often allowed to rest on the ground resulting in increased risk of hive contamination.

### BRIEF DESCRIPTION OF THE DRAWINGS

FIG. 1 illustrates a perspective view of an exemplary embodiment of a horizontal top-bar beehive with the top open;

FIG. 2 illustrates a right side view of the beehive of FIG. 1;

FIG. 3 illustrates a left side view of the beehive of FIG. 1;

FIG. 4 illustrates an end view of the beehive of FIG. 1 as seen from the left in FIG. 2;

FIG. 5 illustrates a cross section view taken along line A-A of FIG. 3;

FIG. 6a illustrates a front view of a supported top-bar in the exemplary embodiment of a modified dual venting horizontal top-bar beehive;

FIG. 6b illustrates an end view of the top-bar of FIG. 6a as from the right in FIG. 6a; and

FIG. 7 illustrates the top view of the cover of the beehive of FIG. 1

### DESCRIPTION

In one aspect, this invention relates to a horizontal top-bar beehive consisting of a hive box, supporting legs, an insulated hinged beehive cover and support system, and an air circulation system that combined reduce maintenance, condensation, and prevent contamination and improves winter survival of the hive.

In another aspect, the present invention relates to a modified dual venting horizontal top-bar hive. The hive is capable of reducing overwintering hive mortality by reducing moisture buildup leading to winter condensation. The invention reduces or eliminates fall maintenance, improves comb integrity, reduces contamination and infestation of the hive through contact with the ground, and facilitates honey extraction. In one aspect, the invention is a system including a longitudinal hive box having a trapezoid cross section containing the brood chambers and harvestable components. The hive box may be supported by four attached legs designed to provide stability and keep the hive off the ground, and has a hinged insulated metal lid. The bottom of the hive may be opened to the outside by means of a screened frame with offset protrusions that provides bottom air circulation, an adjustable bottom board is used to regulate the screen opening to allow for additional air circulation when needed. The top of the hive may have sets of adjustable vents and fixed venting to further regulate ventilation. An adjustable sliding bee entrance with a surrounding landing board may be provided. Along the length of one side of the hive box an inspection window with cover may also be provided. Sitting on the upper lateral edges of the hive box may be located top-bars to which the bees attach their combs. Along the center line there may be a dropped centre known as a comb guide. Protruding from either side of the comb guide may be reinforcement rods that ensure that the comb does not break free during inspection. There may also be spacer bars which may be placed between top-bars. A follower board with a feeding entrance hole may be included to adjust the comb spacing as the hive expands. The top cover or lid of the hive may be covered with white aluminum cladding to reflect sunlight and to protect the wooden members. The interior of the cover may contain a rigid insulation layer to help retain heat in winter and prevent overheating in summer. The top may be hinged and attached to one end of the hive box allowing for ease of opening. A metal leg may be attached to the top cover and folds out to support the cover when open. The hive may be capable of reducing overwintering bee mortality.

In another aspect, the present invention relates to a top-bar beehive including a hive box including two end panels, two side panels and a bottom panel, the hive box having an open top; an insulated top lid for covering the open top of the hive box; a plurality of top-bars extending across the top of the hive box; at least one upper vent in one of the side panels below the horizontal plane formed by the top-bars and above the longitudinal mid-line of the side panel in which the at least one upper vent is located; and at least one lower vent in one of the side panels located below the longitudinal mid-line of the side panel in which the at least one lower vent is located. In the top-bar beehive each top-bar may include a bar and a plurality of rods extending from the face of the top-bar which faces into the hive box when the top-bar is installed in the hive box. The top-bar may further include a tongue along the face of the top-bar which faces into the hive box when the top-bar is installed in the box and wherein the rods are attached to the tongue. The rods may alternatingly be attached to opposite sides of the tongue. The lower vent may include a slit extending parallel the plane of the bottom panel. The bottom panel may be spaced from the hive box and the at least one lower vent is formed by at least one gap between the bottom panel and the bottom of the hive box. The top-bar beehive may further include a hinge for hingedly attaching the lid to the hive box for permitting movement of the lid between a closed position covering the hive box and an open position with the top open, and may further include a hinged leg attached to the top of the lid, whereby opening the lid to a generally horizontal open position allows the leg to hinge open to support the lid above the ground in the open position. The bottom panel may be movably attached to the hive box and movable between a locked position wherein a gap between the bottom panel the bottom panel and the bottom of the hive box forms the bottom vent, and an unlocked position where the gap is increased in width and the bottom panel may be removed from the hive box.

To provide an understanding of the invention, the drawings are designed to illustrate and emphasize the novelty of the horizontal top-bar hive. The illustrations should not be interpreted as limitations to the scope of the invention but rather as illustrations of the basis of the claims.

Various components are common to all top-bar hives and are not necessarily illustrated in detail in this document as these would be well-known and understood by one skilled in the art.

It should be noted that the drawings are not necessarily to scale as their primary function is to illustrate the principles of the invention.

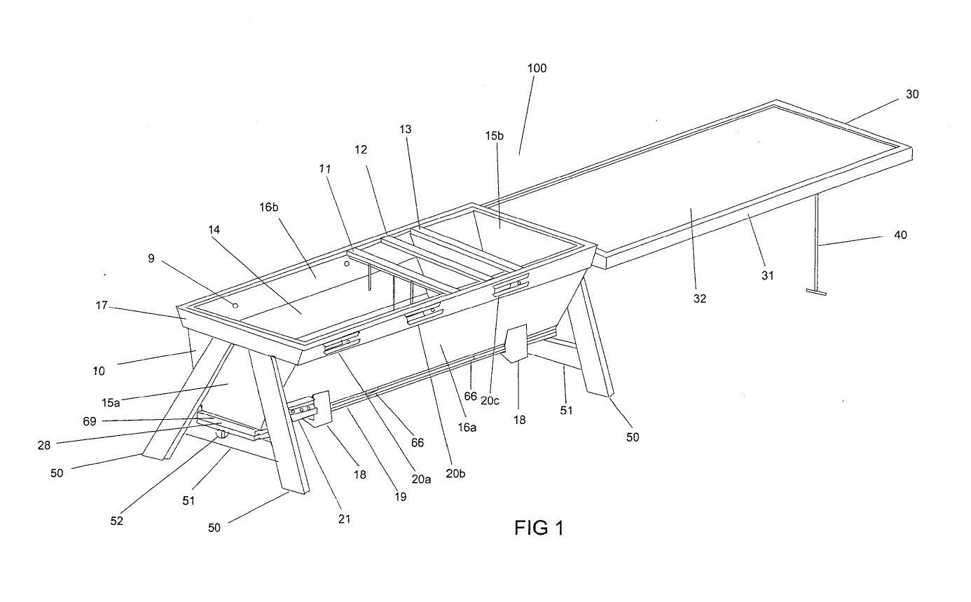

Referring initially to FIG. 1, FIG. 1 illustrates a perspective view of an exemplary embodiment of the modified dual venting horizontal top-bar beehive indicated general by 100. In the present embodiment the modified dual venting horizontal top-bar beehive 100 includes a hive box 10, supporting legs 50 and crossbars 51, hinged hive box lid 30, and hinged hive box lid support 40. In the embodiment shown, the hive box 10 includes a plurality of supported top-bars 11 (only one exemplary top-bar 11 is shown), a plurality of spacer bars 12 (only one exemplary spacer bar 12 is shown), and a follower board 13.

In the current embodiment the hive box 10 is constructed from two end panels 15a and 15b, and two side panels, 16b referred to as the inspection panel and 16a referred to as the venting panel. End panels 15a and 15b are larger at the top and smaller at the bottom with the side edges cut at approximately 20 degrees to the vertical. The panels 15a and 15b are installed in a vertical position. Side panels 16a and 16b are rectangular in shape, approximately three times longer than high and attached to end panels 15a and 15b angled at approximately 20 degrees to the vertical. The top edge of the hive box 10 is surrounded by a wooden collar 17. In the exemplary embodiment the inspection panel 16b has an inspection window 14 with a sliding cover and three ⅜ inch openings 9 through side pane; 16b and the top collar 17 to allow for ventilation on the inspection side. Angled supports 18, two each are attached to the bottom of side panels 16a and 16b to provide support for the bottom plate 19. Along the top collar 17 on side panel 16a, the ventilation panel, three sets of top sliding ventilation units 20a, 20b, and 20c are located. In one lower corner of the ventilation panel is located the bee entrance 21.

In the exemplary embodiment the hive box 10 is supported by four supporting legs 50, these are angled outward and attached to the hive box end panels. The four supporting legs 50, can have a plurality of lengths but all four shall be of similar length. The supporting legs 50 may also be replaced by other suitable supporting structure including fewer or more legs, differently configured legs, a stand or table (not shown). The plurality of lengths is used to adapt to the needs of the beekeeper for working height, moisture control, and stability. At each end of the hive box 10, a crosspiece 51 is fastened to the leg 50, on the leg faces facing the center of the hive. Crosspiece 51 provides rigidity, support, and provides attachment surface for the moisture control offset wheel 52.

In the exemplary embodiment the bottom of the hive box consists of a screen structure 69, attached to a screen frame 28 which can be removed by sliding out through the ends. Below the screen frame 28 is a bottom board 19 painted white to allow for examination of residue dropping from the hive. The bottom board 19 can also be totally or partially removed by sliding it out of the hive ends. When the locking wheel 52 is rotated it can either lock the bottom board 19 to the screen frame 28, and the screen 69 into a closed position or release it to rest downward onto the L-shaped angled supports 18. In the former position air enters the hive via a predetermined gap 67 along the length of the side panels and in the released position ventilation is further increased.

In the exemplary embodiment the hive box 10 has a hive box cover or lid 30 attached by hinges 42 to one end of the hive box collar 17. The lid 30, typically made out of wood, is covered with white aluminum cladding 31 to prevent moisture damage and to reflect sunlight and heat. The lid 30 is lined on the inside with a sheet of rigid insulation 32, the insulation prevents overheating from sun exposure during the summer, and keeping warmth in the hive box during the winter. This insulation 32 plays a key role in preventing condensation on the internal lid surface, which can be deadly to bees, during the winter. Attached to the top of the lid 30 is a hinged metal leg 40. The hinged lid 30 with a swiveling metal leg 40 for supporting the lid 30 facilitates maintenance and also prevents contamination of the hive which could easily occur if the lid 30 were allowed to touch or rest on the ground when opened. With the hive closed, the lid 30 rests on the collar 17.

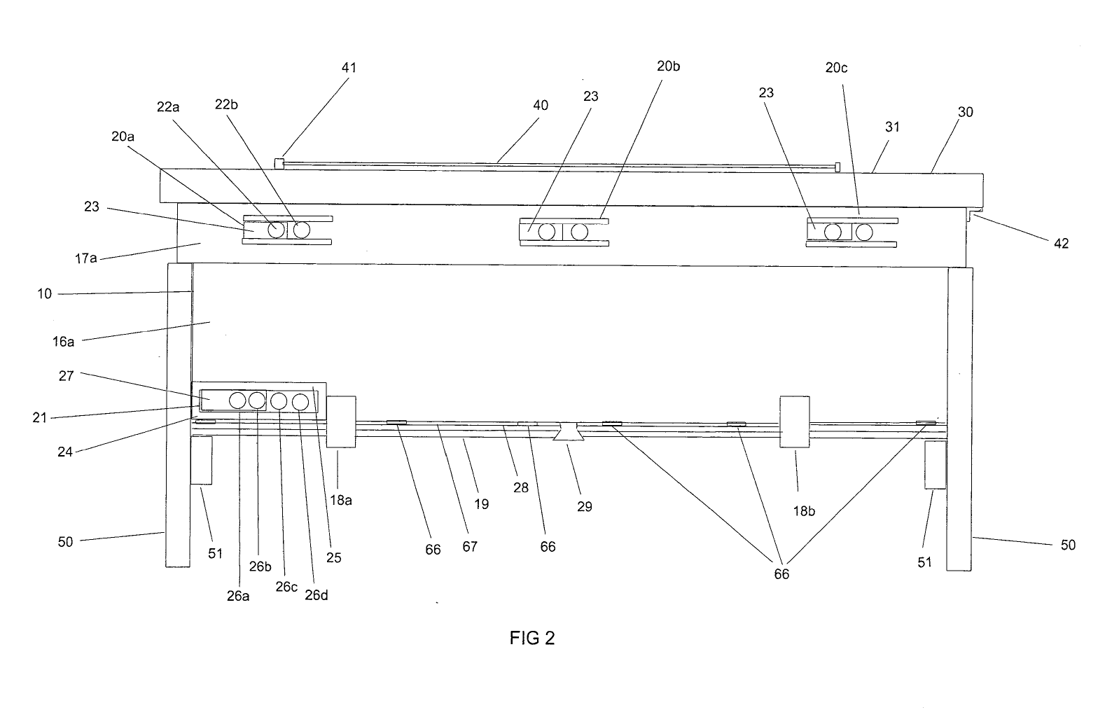

FIG. 2 illustrates an exemplary side view of the modified dual venting horizontal top-bar beehive as viewed from the ventilation side which is characterized by air ventilation side panel 16a. In the FIG. 2, the lid 30 is in place on the hive box 10. Hinges 42 connect the lid 30 to the top hive box collar 17a. The hinged metal leg 40, hinged at point 41 is folded flat against the metal gladding surface 31 of the top 30, and is unfolded when the top 30 swings open.

In the illustrated embodiment the top collar portion 17a contains three top sliding ventilation units 20a, 20b, 20c, each top sliding ventilation unit contains two vent holes 22a and 22b bored through the top collar portion 17a and the side panel 16a to provide ventilation to the interior of the hive box 10. Different embodiments may employ more or fewer top sliding ventilation units or vent holes. These top sliding ventilation units are part of a ventilation system that allows air flow through the hive and reduces moisture buildup. These vent holes also act as means of access for the bees during pollination periods when activity is at its peak. A screened slider 23 controls access to the vent holes of each of the ventilation units 20a, 20b and 20c. The vents may be closed with a solid slider (not shown) during the population period of a new colony to increase the heat levels inside the hive.

In the illustrated embodiment there is a bee entrance 21. The bee entrance consists of a landing board 24, a sheltering overhang 25 and four bee entry apertures 26a, 26b, 26c, and 26d. A sliding door 27 is used as an entrance reducer and can cover up to three apertures 26a, 26b, and 26c in the case for example of a robber event or to reduce cold ingress during the winter season.

Aperture 26d is covered with a ½ inch wire mesh (not shown) to prevent rodents from entering and nesting in winter.

In the illustrated embodiment, the hive box 10 is supported at the ends by the supporting legs 50. A crosspiece 51 provides rigidity to the frame as well as providing the attachment for the off center locking wheels (not visible) that lock and releases the bottom boards 19. When the bottom board 19 and the screen frame 28 are lowered to provide ventilation via the lower portion of the hive box they are further kept in position by the angled supports 18a and 18b, and the central support 29. The central support 29 is cut at an approximately 45 degree angle which accepts the end of the bottom board 19 which also has an approximately 45 degree angle thus ensuring a tight fit.

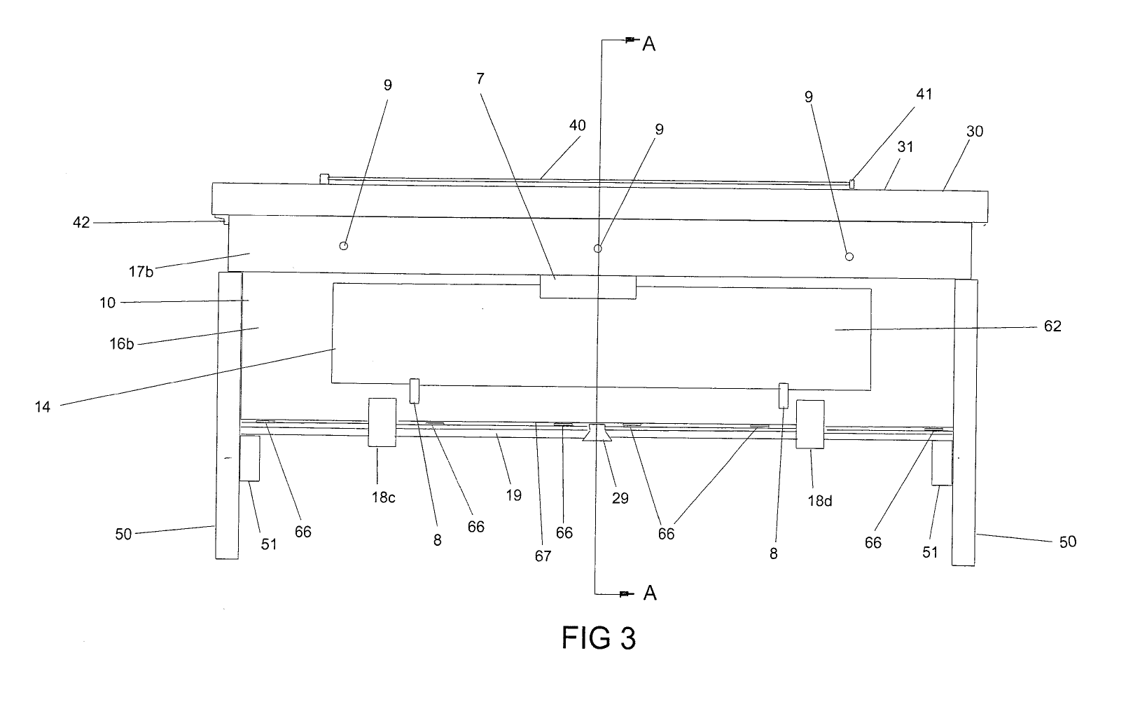

FIG. 3 illustrates an exemplary side view of a modified dual venting horizontal top-bar beehive as viewed from the inspection side panel 16b with lid 30 in place on the hive box 10. The hinges 42 of the hive cover 30 connect the lid 30 to the top hive box collar 17b. The hinged metal leg 40, hinged at point 41 is folded flat against the metal cladding surface 31 of the hive cover 30, and is unfolded when the top 30 swings open.

In the illustrated embodiment the top collar portion 17b contains three auxiliary ventilation apertures 9, each covered with ⅛ inch screens (not shown). The apertures 9 are bored through the top collar portion 17b and the side panel 16b to provide ventilation to the interior of the hive box 10. Different embodiments may employ more or fewer top auxiliary ventilation units or ventilation holes.

In the illustrated embodiment, the side panel 16b has a rectangular inspection window 14 for viewing of the hive's interior. The inspection window 14 can be closed with a opaque cover 62 that is held in place bottom guides 8, and top slotted guide 7.

In the illustrated embodiment, the hive box 10 is supported at the ends by the supporting legs 50. The supporting crosspiece 51 provides rigidity to the frame as well as providing the attachment for the off center locking wheels that locks and releases the bottom board 19.

When the bottom boards 19 are lowered to provide ventilation via the lower portion of the hive box they are further kept in position by the angled supports 18c and 18d, and the central support 29.

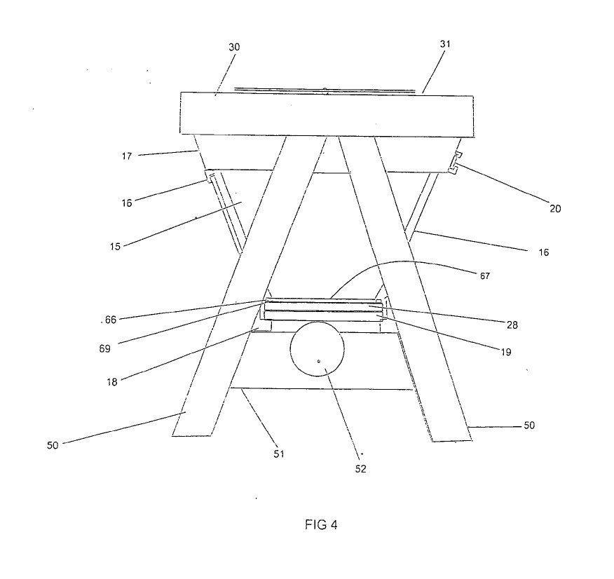

FIG. 4 illustrates an end view of an exemplary embodiment of a modified dual venting horizontal top-bar beehive. FIG. 4 is used to illustrate the mechanism by which ventilation and moisture control is managed in the illustrated embodiment. Support crosspiece 51 attached to supporting legs 50 has attached an off center locking wheel 52. When rotated, the locking wheel can either lock the bottom board 19 and the screen frame 28, and the screen 69 into a closed position against the bottom edge of side panels 16 and the end panels 16 or release it. When released, for example usually during the summer, the bottom board 19 can easily be removed by sliding it out at the ends. Air may enter the hive cavity from the bottom openings and exit via the series of ventilation units 20, 20b, 20c, located along the top collarl7. In the locked position air enters the hive via a gap 67 along the edge of the screen frame 28, screen 69 and bottom board 19. The gap 67 is provided by spacers 66 located above the screen. Usually in winter bees are well adapted to maintaining an acceptable temperature within the hive being able to generate adequate heat as well as closing portions of the gap 67 when needed.

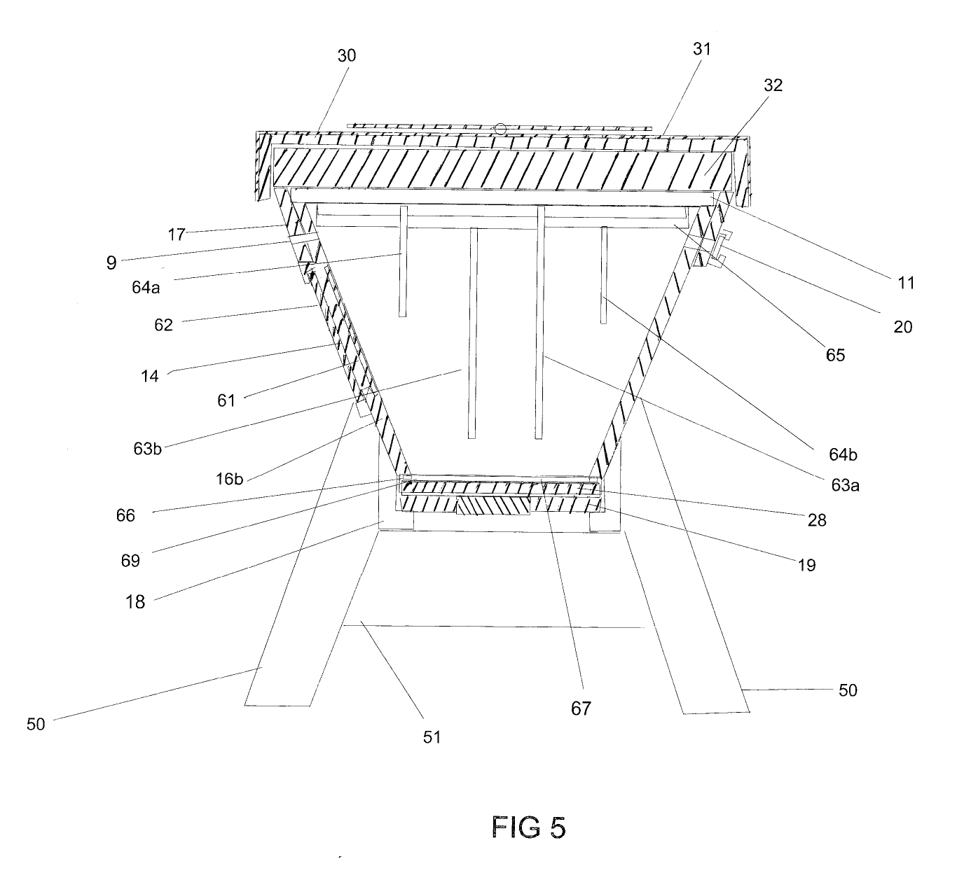

FIG. 5 illustrates a cross section view of an exemplary embodiment of the modified dual venting horizontal top-bar beehive. The inspection window 14 located in side panel 16b contains a longitudinal viewing port 61 made of a transparent material such as plexiglass, which is covered externally by the opaque cover 62. When the cover 62 is removed, it allows for viewing the interior of the hive box 10 and examine the hive's activities. The hive lid 30, when in place, protects the hive box 10 from moisture and temperature extremes. The rigid insulation 32 rests on the hive box top collar 17 and on the top-bars 11 and spacer bars 12.

FIG. 5 illustrates the mechanism by which ventilation and moisture control is managed in the illustrated embodiment. Air entering through the bottom is controlled by the center locking wheel (not shown) attached to support crosspiece 51 which can either lock the bottom assembly of board 19, screen frame 28, and the screen 69 into a closed position or release it to rest downward onto the supports 18. In the locked position air enters the hive via a gap 67 caused by spacers 66 located above the screen 69. In addition the bottom board 19, can easily be removed by sliding it out at the ends to provide additional circulation. Air entering the hive cavity from the gaps 67 and exits via the series of ventilation units 20 located along the top collar 17 and side apertures 9 along the collar on the opposite side. The flow of air can also be reversed with air entering by the ventilation units 20 and exiting via the gaps 67. Usually in winter bees are well adapted to maintaining an acceptable temperature within the hive being able to generate adequate heat. However, in the prior art hives the warm air inside the hive tends to cause the moisture to condense when it reaches the cold cover surface. When the moisture drips on the huddled bees it can create fatal conditions. In the illustrated embodiment, the rigid (non-rigid insulation can also be used) insulation 32 inside of the hive cover 30, coupled with the metal cladding 31, helps to preserve heat and extreme cooling of the interior of the top of the hives couple with the top ventilation units 20 allowing some warm air to escape to help to prevent serious condensation problems.

In the illustrated embodiment most of the components of the horizontal top-bar hive 100 are made of wood construction and painted white. However, other suitable materials may be used in other embodiments. The metal cladding may be omitted from the lid and various types of insulation may be used for the lid or omitted.

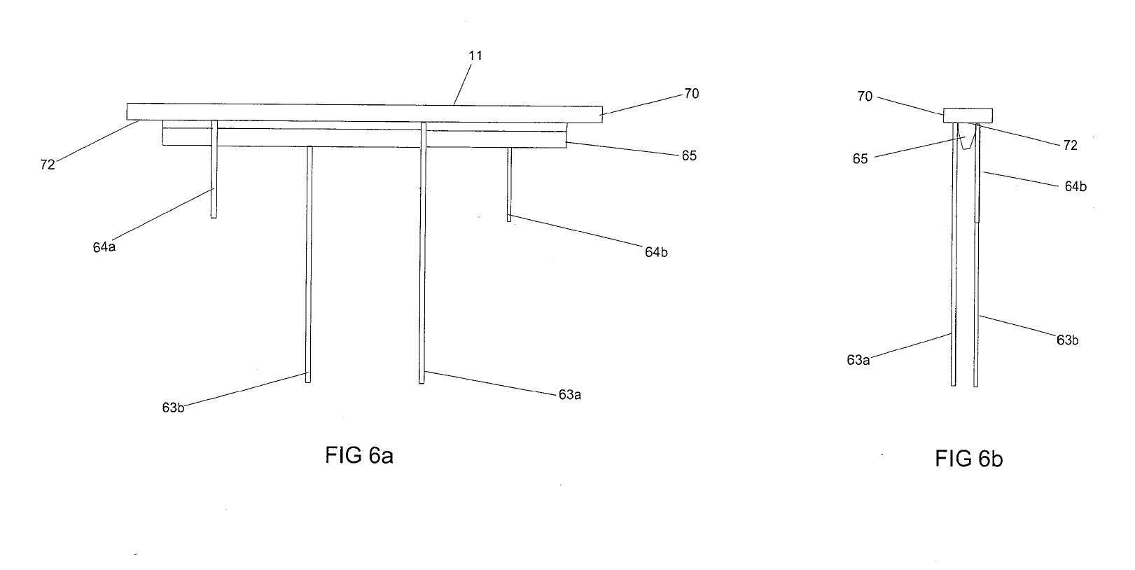

FIGS. 6a and 6b illustrate front and side views of the supported top-bar 11 in the exemplary embodiment of the modified dual venting horizontal top-bar beehive 100. The top-bar 11 typically consists of a bar 70 and an attached comb guide 65. A notch 72 created by the bar 70 and comb guide 65 rests on a ledge formed by the hive box's side panels and the top collar 17. The top-bar has a dropped center point with side angles of 20 degrees where the bees attach the comb. This is known as the comb guide 65. The comb guide 65 is reinforced by a plurality of thin comb support rods 63a, 63b, and 64a and 64b. In the illustrated embodiment four rods are shown, 63a and 63b being approximately three inches long and 64a and 64b being approximately eight inches long. The comb support rods are placed on alternate sides of the comb guide 65 such that comb support rods 64a and 63a are fastened on one side of the comb guide 65, and support rods 64b and 64a are fastened on the other side of the comb guide 65. The comb support rods are designed to prevent comb breakage particularly during comb removal and when the comb is tilted.

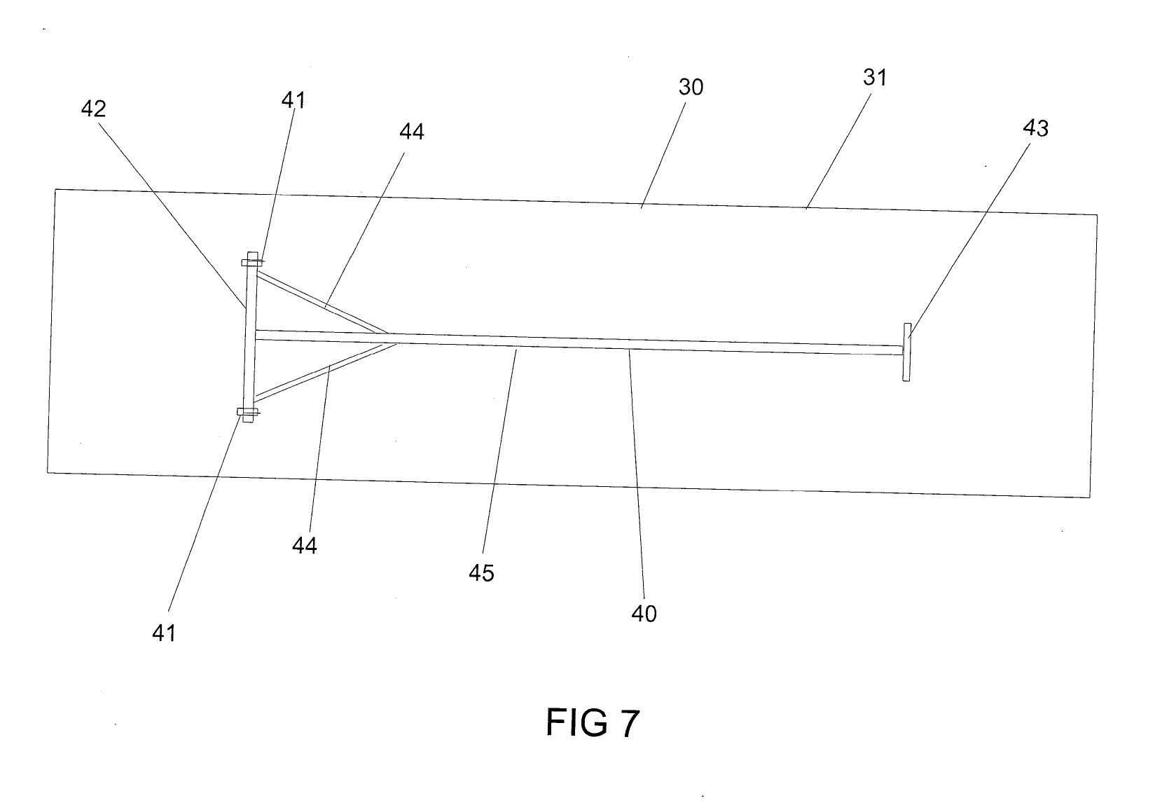

FIG. 7 illustrates a top view of the lid 30 in the exemplary embodiment of a horizontal top-bar beehive.

The hinged hive box lid 30 as viewed from the top includes white metal cladding 31 and the hinged metal leg 40. The metal leg 40 structure includes a swinging “T” shaped structure 42, a longitudinal rod or stem 45, two lateral supports 44, and a foot section which provides a support surface when the metal leg 40 is deployed. The metal leg 40 is fastened to the top of lid 30 by means of two brackets 41 such that they allow the leg 40 to automatically deploy itself using gravity and position itself to support the top cover 30 when the hive is opened. The metal leg 40 returns to its original folded position when the lid 30 is closed. The metal leg 40 and the hinged lid 30 allows for ease of opening of the hive box and prevents the lid 40 cover from touching the ground thus preventing direct ground contamination and infestation from crawling pests.

What is claimed is:

1. A top-bar beehive comprising:
a hive box including two end panels, two side panels and a bottom panel, the hive box having an open top;
an insulated top lid for removably covering the open top of the hive box;
a plurality of top-bars extending across the top of the hive box;
at least one upper vent in one of the side panels below the horizontal plane formed by the top-bars and above the longitudinal mid-line of the side panel in which the at least one upper vent is located; and
at least one lower vent in one of the side panels located below the longitudinal mid-line of the side panel in which the at least one lower vent is located.

2. The top-bar beehive of claim 1, wherein each top-bar comprises a bar and a plurality of rods extending from the face of the top-bar which faces into the hive box when the top-bar is installed in the hive box.

3. The top-bar beehive of claim 2, wherein the top-bar further comprises a tongue along the face of the top-bar which faces into the hive box when the top-bar is installed in the box and wherein the rods are attached to the tongue.

4. The top-bar beehive of claim 3, wherein the rods are alternatingly attached to opposite sides of the tongue.

5. The top-bar beehive of claim 1, wherein the lower vent comprises a slit extending parallel the plane of the bottom panel.

6. The top-bar beehive of claim 1, wherein the bottom panel is spaced from the hive box and the at least one lower vent is formed by at least one gap between the bottom panel and the bottom of the hive box.

7. The top-bar beehive of claim 1, further including
a hinge for hingedly attaching the lid to the hive box for permitting movement of the lid between a closed position covering the hive box and an open position with the top open, and
further including a hinged leg attached to the top of the lid, whereby opening the lid to a generally horizontal open position allows the leg to hinge open to support the lid above the ground in the open position.

8. The top-bar beehive of claim 1, wherein the bottom panel is movably attached to the hive box and movable between a locked position wherein a gap between the bottom panel the bottom panel and the bottom of the hive box forms the bottom vent, and an unlocked position where the gap is increased in width and the bottom panel may be removed from the hive box.
